(19) United States
(12) Patent Application Publication
(10) Pub. No.: US 2012/0266961 A1
(43) Pub. Date: Oct. 25, 2012

(54) WATER CONSERVATION SYSTEMS AND METHODS OF USING THE SAME

(76) Inventor: Tiffany Natasha Holmes, Kennesaw, GA (US)

(21) Appl. No.: 13/089,778

(22) Filed: Apr. 19, 2011

(51) Int. Cl. F15D 1/00; F16K 21/00

(52) U.S. Cl. 137/1; 137/468

(57) ABSTRACT

A water conservation system for distributing water is provided. The water conservation system includes (a) a fixture member including a first opening and being configured to transport a flow of distributed water; (b) a monitoring assembly configured to sense a temperature characteristic of the flow of distributed water; and (c) a valve assembly located adjacent the first opening and being configured to divert the flow of distributed water away from the first opening when the temperature characteristic remains below a threshold value. In certain embodiments, the water conservation system may further include a water recycling assembly configured for recirculation of the distributed water to any of a variety of appliances. A method of using the water conservation system is also provided.

### TECHNOLOGICAL FIELD

Embodiments of the invention may relate generally to water conservation and more particularly, may relate to methods, apparatuses and systems for providing an efficient manner in which to output water at a desired temperature.

### BACKGROUND

Traditional water distribution systems may provide water to various fixtures, such as sinks, bathtubs, showers, dishwashers, and salon wash bowls, which are located throughout residential or industrial structures. Such systems may provide ambient temperature water from an external source to an internal piping system. The piping system then distributes the ambient water either directly to the fixtures or indirectly, after first passing it through a water heater, which may heat the water to a desired temperature prior to distribution to the fixtures. At the fixtures, the ambient and hot water may flow through separate hot and cold water control valves that are typically independently user-operated or the water may be mixed at a single valve such that a desired water temperature is output from the fixtures.

A common problem of such systems is that hot water is generally not readily available at the fixtures upon demand. This problem may typically arise because any previously provided hot water, having sat in the piping system and cooled over a period of time (e.g., overnight), must be dispensed before any freshly heated water can be dispensed at the fixtures. This problem is particularly noticeable for fixtures located at an appreciable distance from the hot water heater or in facilities having poorly insulated piping systems. When encountering the problem of providing hot water on demand, most users simply leave the fixtures turned on (e.g., running water) until the cooled hot water has been removed and the newly provided hot water arrives. This method, however, may be inefficient and may waste a great deal of otherwise potable water, sending the water down the drain unused for expensive refurbishment at a water treatment facility.

Other users, when encountering the problem of providing hot water on demand, have devised complex systems for managing water flow routes. Such systems, due at least in part to their complexity, have been shown to be inefficient when used over an extended period of time.

Further, such systems are oftentimes difficult to install in existing structures, and may permit little flexibility in adapting to various parameters of new or existing structures.

Accordingly, in view of the foregoing drawbacks, a need may exist for a simple, convenient, and efficient system that may be readily adapted for and installed within a variety of new and existing structures alike.

### BRIEF SUMMARY

A system, apparatus and method are therefore provided that may enable the provision of an efficient and reliable mechanism for distributing or outputting water at a desired temperature. Additionally, in an example embodiment, water that may not be at a desired temperature may, but need not, be recycled until the desired temperature is reached. In accordance with an example embodiment of the invention, a water conservation system is provided for distributing water. The water conservation system may include (a) a fixture member including a first opening and being configured to transport a flow of distributed water; (b) a monitoring assembly configured to sense a temperature characteristic of the flow of distributed water; and (c) a valve assembly located adjacent the first opening, the valve assembly may be configured to divert the flow of distributed water away from the first opening when the temperature characteristic remains below a threshold value. In certain example embodiments, the water conservation system may further include a water recycling assembly configured to transport the flow of distributed water away from the fixture member when the temperature threshold remains below the threshold value.

In accordance with another example embodiment of the invention, a water conservation system is provided for distributing water. The water conservation system, in at least some example embodiments, may include: (a) a fixture member having an internal passageway, the passageway having a first opening, the passageway being configured to transport a flow of distributed water; (b) a monitoring assembly that may be configured to sense a temperature characteristic of the flow of distributed water within the passageway; and (c) a valve assembly configured to: (1) transport the flow of distributed water through the first opening when the temperature characteristic meets or exceeds a threshold value; and (2) transport the flow of distributed water away from the first opening when the temperature characteristic remains below the threshold value.

In accordance with another example embodiment of the invention, a method of using a water conservation system for distributing water is provided. The method may include: (a) determining a threshold temperature characteristic for a flow of distributed water through a fixture member, the fixture member comprising a first opening; (b) supplying the flow of distributed water through the fixture member; (c) sensing a current temperature characteristic for the flow of distributed water through the fixture member; (d) comparing the current temperature characteristic to the threshold temperature characteristic; and (e) diverting the flow of distributed water away from the first opening in response to a determination that the current temperature characteristic is less than the threshold temperature characteristic.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is side elevation view of a water conservation system 1 according to a first example embodiment of the invention;

FIG. 2 is a side elevation view of a fixture assembly 5 of the water conservation system 1 of FIG. 1 according to an example embodiment of the invention;

FIG. 3 is a side elevation view of a fixture assembly 105 according to second another example embodiment of the invention;

FIG. 4 is a side elevation view of a water conservation system 201 according to third another example embodiment of the invention;

FIG. 5 is a side elevation view of a water recycling assembly 230 of the water conservation system 101 of FIG. 4 according to an example embodiment of the invention;

FIG. 6 is a side elevation view of a water recycling assembly 330 according to a fourth example embodiment of the invention;

FIG. 7 is a side elevation view of a water recycling assembly 430 according to a fifth example embodiment of the invention;

FIG. 8 is a side elevation view of a water recycling assembly 530 according to a sixth example embodiment of the invention;

FIG. 9 is a side elevation view of a water recycling assembly 630 according to a seventh example embodiment of the invention;

FIG. 10 is a side elevation view of a water recycling assembly 730 according to an eighth example embodiment of the invention;

FIG. 11 is a side elevation view of a fixture assembly 805 according to a ninth example embodiment of the invention;

FIG. 12 is a front elevation view of a fixture assembly 905 according to a tenth example embodiment of the invention; and

FIG. 13 is a front view of a digital monitor 1040 according to an example embodiment of the invention.

### DETAILED DESCRIPTION

Various embodiments of the present invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Unless otherwise defined, all technical and scientific terms used herein have the same meaning as commonly understood by one of ordinary skill in the art to which this invention belongs. The terminology used in the description is for describing particular embodiments only and is not intended to be limiting to embodiments of the present invention. As used in the description, the singular forms “a,” “an,” and “the” are intended to include the plural forms as well, unless the context clearly indicates otherwise. The term “or” is used herein in both the alternative and conjunctive sense, unless otherwise indicated. The terms “illustrative” and “exemplary” are used to be examples with no indication of quality level.

Unless otherwise indicated, all numbers expressing quantities of dimensions such as length, width, height, and so forth as used in the description are to be understood as being modified in all instances by the term “about.” Accordingly, unless otherwise indicated, the numerical properties set forth in the description are approximations that may vary depending on the desired properties sought to be obtained in embodiments of the present invention. Notwithstanding that the approximate numerical ranges and parameters setting forth the broad scope of embodiments of the present invention, the numerical values set forth in the specific examples are reported as precisely as possible.

### STRUCTURE OF AN EXAMPLE EMBODIMENT OF THE INVENTION

### Water Conservation System 1

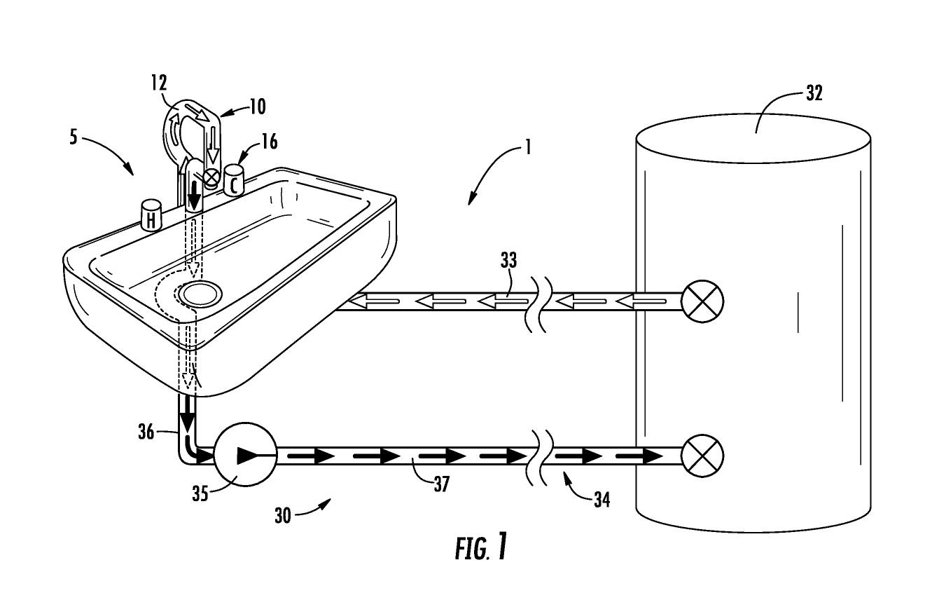

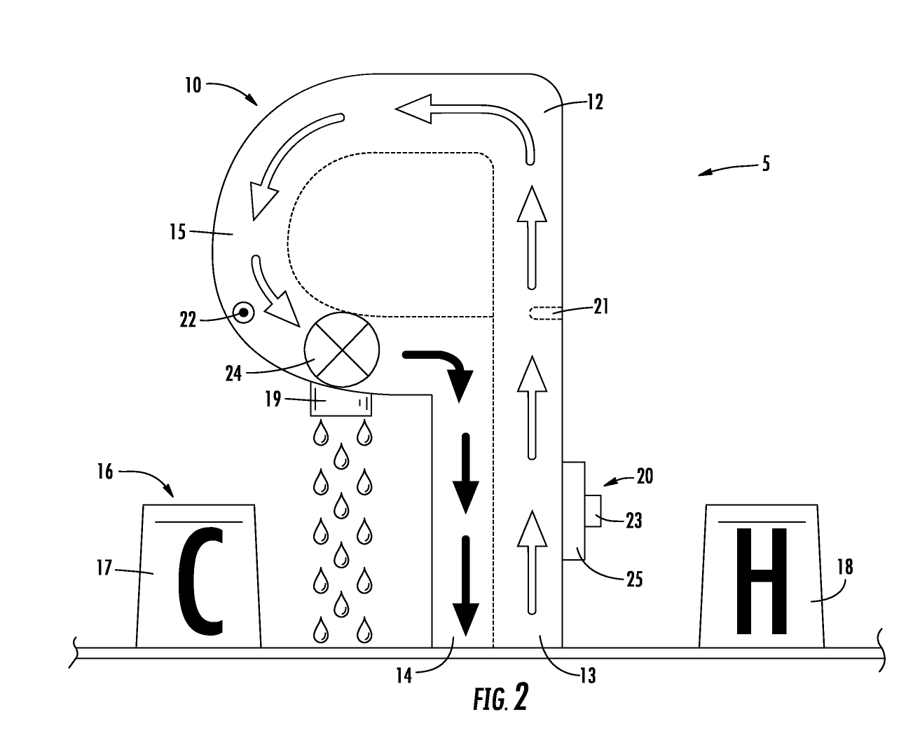

Reference is now made to FIG. 1, which illustrates a water conservation system 1 comprising a fixture assembly 5 and a recycling assembly 30. The fixture assembly 5 according to various example embodiments may include a fixture member 10, which further includes a flow passage 12, a water adjustment assembly 16 (see e.g., FIG. 2), a monitoring assembly 20 (see e.g., FIG. 2), and a valve assembly 24, as will be described in further detail below. Returning to FIG. 1, the recycling assembly 30 according to various embodiments may include a hot water heater 32, an electric circulation pump 35, a first pipe 33, and a second pipe 34. While in the illustrated embodiment, the water heater 32 may be shown as a conventional model, it should be appreciated that other types of water heaters, such as a non-limiting example of a tank-less water heater, may be used in accordance with certain embodiments of the invention.

The pump 35 according to various example embodiments may be a single, small pump of the type generally used in residential and/or industrial hot water space heating. The pump 35 in certain example embodiments may be configured to provide sufficient water flow to ensure that unused water is effectively and efficiently returned to the water heater 32. In other embodiments, to avoid reduced flow within the recycling assembly 30, a check valve (not shown) may also be plumbed in parallel with the pump 35 or incorporated within the pump housing. In those embodiments, when the pump 35 is powered and flow demand is low or nonexistent, such a check valve may assist with prevented subsequently boosted flow from re-circulating back through the pump's inlet. In other embodiments, the pump 35 may simply be deactivated when flow demand is low or nonexistent, as will be described in further detail below. In still other embodiments, neither a pump 35 nor a check valve may be necessary, depending on the natural environment within which the recycling assembly 30 is installed.

Referring to the illustrated embodiment of FIG. 1, the pump 35 is depicted as a small, single circulating model. However, it should be appreciated that other types and/or designs of pumps, as commonly known and understood in the art, may be employed in accordance with various other embodiments of the invention. For example, certain embodiments may incorporate a displacement type pump as pump 35, forcing water in the second pipe 34 to move toward the water heater 32, as described in further detail below. In other embodiments, the pump 35 may be a centrifugal pump, using an impeller or propeller to spin the water rapidly such that it passes through the pump. In still other embodiments, any of a variety of commonly known and understood pumps 35 may be incorporated within the recycling assembly 30.

The first pipe 33, according to various embodiments of the invention may serve as one of two water supply lines (the other, an ambient temperature water line, not shown) for the water conservation system 1. The first (e.g., supply) pipe 33, in certain embodiments, may provide hot water from the hot water heater 32 to the fixture member 10. The first pipe 33 may be constructed from a variety of materials commonly known and used in residential and industrial water piping systems, including but not limited to examples such as copper, polyvinyl chloride (PVC), and acrylonitrite-butadiene-styrene (ABS), etc.

The second pipe 34 according to various embodiments may serve as a water return line and may include a runoff portion 36 and a recirculation portion 37. The runoff portion 36 in certain embodiments may be configured to provide a water drainage pathway between the fixture member 10 and the pump 35, while the recirculation portion 37 may be configured to provide the same between the pump 35 and the water heater 32. In other embodiments, in which a pump 35 may not be necessary, the runoff portion 36 and the recirculation portion 37 may be coupled directly to one another. In still other example embodiments, the runoff portion 36 and the recirculation portion 37 may be formed from a single integral length of pipe. In this manner, various embodiments of the invention may provide a continuous pathway from the fixture member 10 to the water heater 32 for conservation (e.g., recirculation) of potable water that may not have yet reached a desired temperature (as will be described in further detail below). It should be appreciated that the second (e.g., return) pipe 34 (like the first (e.g., supply) pipe 33, and as well as any additional pipes described hereinafter) may be constructed from materials including, but not limited to, examples such as copper, polyvinyl chloride (PVC), and acrylonitrite-butadiene-styrene (ABS), etc.

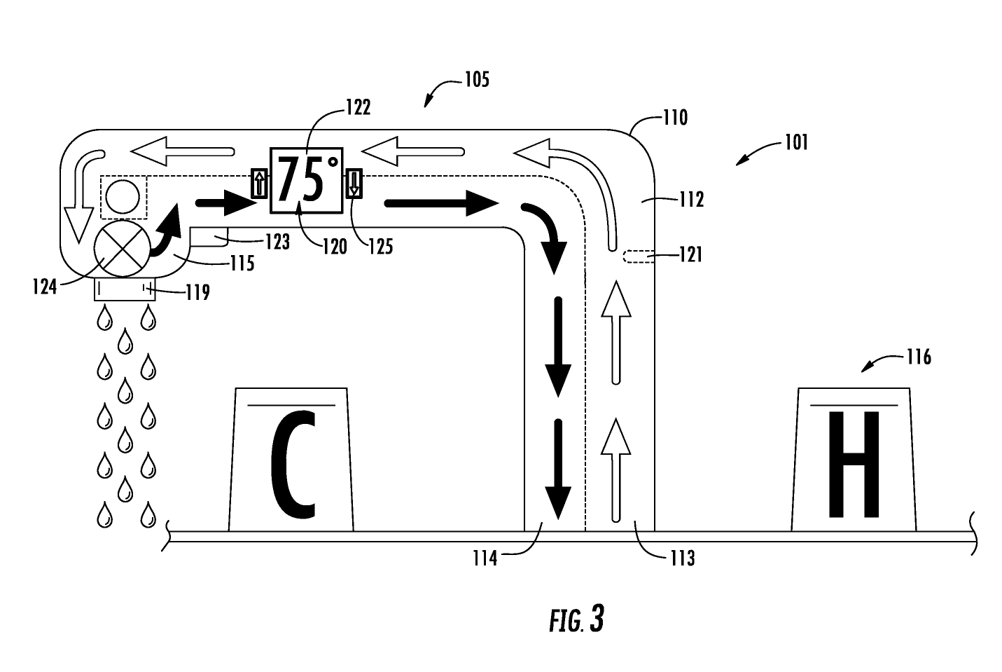

In operation, as will be described in further detail below, a user desiring water of a certain temperature to be dispensed from a fixture, may, in accordance with various embodiments, activate the water conservation system 1 such that cooled potable water located in the first pipe 33 may be re-circulated through the fixture assembly 5 (e.g., not dispensed to the user) via the second pipe 34. In certain example embodiments, activation of the system 1 likewise may activate the pump 35 such that the returned cooled potable water is carried through the second pipe 34 and back to the water heater 32 for reheating. In these and still other example embodiments, activation of the system 1 likewise may pull freshly heated water from the water heater 32 and to the fixture assembly 5 via the first pipe 33. In an instance in which the system 1 determines that the mixture of water passing through the fixture assembly 5 has reached a predetermined (e.g., user-selected) threshold may the system divert the water from the second pipe 34 to a spigot 19, as shown in at least FIG. 2 (see e.g., also spigot 119 of FIG. 3) and described in further detail below.

### Fixture Assembly 5

Turning now to FIG. 2, the fixture assembly 5 will now be described in greater detail. The fixture assembly 5 according to various example embodiments may include a fixture member 10, a water adjustment assembly 16, a monitoring assembly 20, and a valve assembly 24. In at least the illustrated embodiment, the fixture member 10 may form a substantially “P-shaped” configuration, as described in greater detail below. However, it should be appreciated that in other example embodiments the fixture member 10 may take any of a variety of shapes or sizes, provided such are configured to provide a closed passage 12 that enables the desired degree of water conservation. In various embodiments, the fixture member 10 may be constructed from any of a variety of materials, including but not limited to, examples such as brass and chrome, etc. The fixture member 10 according to such and other embodiments may be coated with a finish, such as nickel, satin, enamel, and stainless steal for various fixtures located through residential and/or industrial structures. In this manner, the fixture member 10 may provide an appearance comparable to that of commercially available and widely installed fixtures and/or faucets.

As further illustrated by FIG. 2, the fixture member 10 according to various embodiments may form a closed water flow passage 12 having a single opening or spigot 19. The passage 12 generally includes an inlet portion 13, a recirculation portion 14, and an intermediate portion 15. The inlet portion 13 according to various embodiments is configured to be operatively connected to at least the first pipe 33 of the recycling assembly 30 (see FIGS. 1), which provides hot water to the fixture, and an ambient water supply pipe (not shown). In this manner, the inlet portion 13 according to certain embodiments is configured to seamlessly integrate with pre-existing fixtures and/or faucet assemblies, whether pre-existing within a structure or packaged for new installation.

The inlet portion 13 according to various embodiments may be elongated and substantially vertically oriented. In this manner, the inlet portion 13 may ensure that certain embodiments are positioned sufficiently above a sink (or other item) upon which the fixture member 10 may be mounted. In these and other example embodiments, an upper end of the inlet portion 13 is coupled to the intermediate portion 15, which further ensures that this and other embodiments are positioned sufficiently over the sink (or other item) upon which the fixture member 10 is mounted. In at least the illustrated embodiment, the intermediate portion 15 may form a substantially curved portion, extending both outwardly and downwardly relative to the upper end of the inlet portion 13. However, in other embodiments, it should be appreciated that the intermediate portion 15 may form any of a variety of shapes or configurations, provided such permit the free flow of water through the passage 12.

The recirculation portion 14 according to various embodiments provides a route through which potable water that has not yet reached a desired temperature (as discussed in further detail below) may be re-circulated and thus recycled through the water conservation system 1. In certain embodiments, the recirculation portion 14 is elongated and substantially vertically oriented. In other embodiments, the recirculation portion 14 may be substantially similar in shape/size and configuration as the inlet portion 13, while in still other embodiments, the recirculation portion may be at least some degree shorter in length than the inlet portion. In this manner, the recirculation portion 14 may provide a water transport pathway from the intermediate portion 15 located sufficient above and over the sink and to second pipe 34. In these and other embodiments, an upper end of the recirculation portion 14 is coupled to the intermediate portion 15 while a lower end of the recirculation portion 14 is positioned adjacent a lower end of the inlet portion 13. In this manner, certain example embodiments may be configured to be installed on pre-existing sinks having a single opening for receiving a lower portion of the fixture member 10.

The recirculation portion 14 and the inlet portion 13 according to various embodiments, as illustrated in FIG. 2, may be configured as separate, adjacently positioned pipes that, together with the intermediate portion 15 form the “P-shaped” configuration of the fixture member 10. In other embodiments, these portions, 13-15, may be wholly contained within a fixture member 10 formed as a single integral body, when examined externally. In still other embodiments, the portions, 13-15, and the fixture member 10 may be configured in any of a variety of manners, at least some of which will be described in further detail below.

In various embodiments, the passage 12 (including, in certain embodiments, portions 13-15) may be constructed from any of a variety of materials suitable for the distribution of water, including but not limited to, examples such as copper, polyvinyl chloride (PVC), and acrylonitrite-butadiene-styrene (ABS), etc. Further, in certain embodiments the inlet portion 13, the recirculation portion 14, and the intermediate portion 15 may be formed from a single piece of material. In other embodiments, each of the portions 13-15 may be individually formed and subsequently assembled. In these and still other embodiments, each individually formed portion, 13-15, may be operatively assembled relative to one another in any of a variety of methods such as, for example, adhesives, couplers, and welding, etc.

Referring to FIG. 2, the water adjustment assembly 16 of the fixture assembly 5 according to various embodiments may include a cold water knob 17 and a hot water knob 18. Such a configuration, may enable a user to turn the dual knobs 17, 18 relative to one another such that a desired degree of cold and/or hot water are mixed together prior to entering the fixture member 10. Typically, a bypass valve (not shown) may control the relative amounts of hot and/or cold water mixed for supply to the fixture member 10, dependent upon the relative degrees to which the user turns the knobs 17, 18. Although at least the illustrated embodiment is shown with a dual-knob configuration, it should be understood that various other embodiments of the water adjustment assembly 16 of the fixture assembly 5 may include a single knob that may be rotated about a single axis by approximately 180 degrees, with rotation towards the left increasing the relative amount of hot water provided to the fixture member 10 and rotation to the right increasing the relative amount of cold water provided to the fixture member. Such a configuration, may operate together with a spherical ball valve (not shown) to enable a user to control the mixture of water entering the fixture member 10 and thus the resulting temperature of the water when dispensed.

The fixture member 10 according to various embodiments may include an opening or spigot 19 that permits the dispensing of water from the fixture member 10 upon request by the user (e.g., by operating the water adjustment assembly 16, as previously described). In certain example embodiments, the spigot 19 may be formed within the intermediate portion 15 of the flow passage 12. However, in other embodiments, the spigot 19 may be formed within any portion of the flow passage 12 provided it is positioned sufficiently above and over an adjacently positioned sink or container that any water dispensed from the spigot is contained within,

As further illustrated by FIG. 2, the fixture member 10 according to various embodiments may include a monitoring assembly 20, which may include a controller 25, a temperature sensor 21, an indicator 22, and a release member 23. The controller 25 according to various embodiments may be any of a variety of controllers (e.g., processors, microprocessors, etc.). In certain embodiments, the controller 25 may be provided separately from the pump 35, the sensor 21, and the valve 24. In other embodiments, the controller 25 may be integral with one or more of the pump 35, the sensor 21, and/or the valve 24. In still other embodiments, the controller 25 may be provided in any of a variety of fashions such that a desired degree of control is achieved over certain elements of the system 1. In even further embodiments, the monitoring assembly 20 may not include a controller 25, with those embodiments instead being configured for manual operation by a user.

The temperature sensor 21 according to certain embodiments may be located proximate (e.g., at or near) the inlet portion 13 of the fixture member 10. In other embodiments, the temperature sensor 21 may be located proximate the valve assembly 24. In still other embodiments, the temperature sensor 21 may be located at any of a variety of positions relative to the water conservation system 1 provided such is sufficient to enable the sensor to accurately and efficiently read the temperature of the water flowing into and through the fixture member 10.

The temperature sensor 21 according to various embodiments may be configured to detect a flow characteristic of temperature, such as a temperature value or a change in temperature as water flows through the water conservation system 1. In certain embodiments, the sensor 21 may be configured to automatically detect the flow of water through the water conservation system 1 and in response may activate one or more of the water pump 35 or the valve 24. In other embodiments, the sensor 21 may be configured for manual activation, such as, for example, upon activation of the broader water conservation system 1 by a user, as described in further detail below.

The temperature sensor 21 according to various embodiments may communicate with the controller 25, which in turn may communicate with the water pump 35, as previously described herein. In certain embodiments, the operation of the water pump 35 may be controlled by the temperature sensor 21 (e.g., via the controller 25) such that the pump is turned off when the sensor determines that temperature of the water reaches a predetermined threshold, as defined, for example, by a user of the system 1. In other embodiments, the operation of the valve assembly 24 may likewise be controlled by the temperature sensor 21 (e.g., also via the controller 25) such that certain pathways within the valve assembly may be closed when the sensor determines that the temperature of the water reaches the predetermined threshold. In still other embodiments, the pump 35 and the valve assembly 24 may be turned on or opened when the sensor determines that the temperature of the water has not yet reached (or, alternatively, falls below) the predetermined threshold.

The indicator 22 according to various embodiments may be positioned adjacent to and external to the fixture member 10. In certain embodiments, the indicator 22 may be formed separately from the fixture member 10 and affixed thereto using any of a variety of methods, including, but not limited to, an adhesive, for example. In other embodiments, the indicator 22 may be formed as an integral part of the fixture member 10. In any of these and other example embodiments, the indicator 22 may be formed on the intermediate portion 15 of the fixture member 10 such that it is prominently visible to a user of the same. In still other example embodiments, the indicator 22 may be formed anywhere else on the fixture member 10 or even, alternatively separate and external from the fixture, provided any such placement of the indicator ensures prominent visibility of the same for the user.

As shown in FIG. 2, the indicator 22 according to various example embodiments may provide an intermittent display by, for example, turning on a light (e.g., LED) upon satisfaction of a certain condition, such as, for example, a predetermined and desired water temperature threshold. In other embodiments, the indicator 22 may be configured to provide a continual display of the most recently observed condition, as may be seen, for example, in the digital temperature gauge 122 of at least FIG. 3. In any of these and other example embodiments, the display, whether intermittent or continual, may be determined via the controller 25, as previously described.

The release member 23 according to various embodiments may be positioned adjacent to and external to the fixture member 10. In certain embodiments, the release member 23 may be positioned adjacent the controller 25, as shown in at least FIG. 2. In other embodiments, the release member 23 may be positioned anywhere on the fixture member 10, such as, for example, adjacent the spigot 119 as shown in FIG. 3. In still other embodiments, the release member 23 may be positioned separate from the fixture member 10 in any of a variety of locations provided the release member is relatively easy for a user of the water conservation system 1 to access during operation of the system.

The release member 23 according to various embodiments may be configured as a push button or, alternatively, as any of a variety of user-activated releases mechanisms. In certain example embodiments, the push button 23 may be configured such that upon depression by a user, water flow within the fixture member 10 may be diverted (e.g., via a valve assembly 24, as described further below) through the spigot 19 of the member. In other embodiments, the push button 23 may be alternatively configured such that depression by a user diverts the water flow away from the spigot 19 and into the recirculation portion 14 of the flow passage 12. In any of these and other embodiments, the operation of the release member 23 may be performed manually (e.g., by the user) or, alternatively, automatically (e.g., by activating the member via, for example, the controller 25).

The fixture member 10 according to various embodiments may further include a valve assembly 24, as illustrated in at least FIG. 2. The valve assembly 24 according to various embodiments may include at least one valve configured for positioning within the flow passage 12 of the fixture member 10. In certain embodiments, the valve assembly 24 comprises a diverter-type valve that is configured to be operated by a user via, for example, a push-button, which may be separate yet similar to or, alternatively, integral to the release member 23. In other example embodiments, the valve assembly 24 may include a diverter-type valve that is configured for automatic operation (e.g., via the controller 25, as previously described). In still other example embodiments, the valve assembly 24 may be selected from any of a variety of valves capable of diverting a liquid flow from a first exit channel to a second exit channel.

The valve assembly 24 according to various embodiments may be positioned within the flow passage 12 of the fixture member 10, as illustrated in at least FIG. 2. In certain embodiments, the valve assembly 24 may be positioned within the intermediate portion 15 of the flow passage and at least substantially adjacent to the spigot 19 of the fixture member 10. In other example embodiments, the valve assembly 24 may be positioned further downstream in the flow passage 12 relative to the spigot 19. In still other example embodiments, the valve assembly 24 may be positioned in any of a variety of locations within the flow passage 12 that are not upstream of the spigot 19.

The valve assembly 24 according to various embodiments may be configured to selectively prevent or allow water flow through either the recirculation portion 14 or the spigot 19. In certain embodiments, in an instance in which the valve assembly 24 is configured to prevent water flow through the recirculation portion 14, water is automatically diverted through the spigot 19 (e.g., dispensed from the fixture member 10). In other embodiments, when the valve assembly 24 is configured to prevent water flow through the recirculation portion 14, a notification, via for example the indicator 22 may notify a user of such configuration, at which time the user may then manually configure the valve assembly 24 to dispense the water through the spigot 19. In any of these and other example embodiments, the valve assembly 24 may be configured to manually or automatically prevent water flow through the recirculation portion 14 upon determining (e.g., manually or, alternatively via, for example, the controller 25) that a pre-determined water temperature threshold (e.g.,)75° has been satisfied. In this regard, the valve assembly 24 may allow the water having the predetermined temperature to be released via the spigot 19. Likewise, upon determining (again manually or via the controller 25) that the predetermined water temperature threshold has not yet (or is no longer) been satisfied, the valve assembly 24 may be configured to manually or automatically permit water flow through the recirculation portion 14 to the water recycling assembly 30.

### Fixture Assembly 105

While the certain embodiments of the water conservation system 1 illustrated in FIGS. 1-2 have been described as including a fixture assembly 5, various embodiments of a water conservation system 101 may include an alternatively configured fixture assembly 105. In certain of these embodiments, as illustrated in FIG. 3, the fixture assembly 105 may likewise include a fixture member 110 including a flow passage 112, an inlet portion 113, a recirculation portion 114, and an intermediate portion 115. However, in these and various other example embodiments, the fixture member 110, and in particular the inlet portion 113 and the recirculation portion 114 may be further elongated relative to those configurations previously described.

Further, the inlet portion 113 and recirculation portion 114 according to various embodiments may be substantially “L-shaped.” In this manner, each of the inlet and recirculation portions 113-114 may have a first portion that is substantially vertically-oriented and a second portion that is substantially horizontally-oriented upon standard installation of the fixture assembly 105. Such a configuration may ensure that the intermediate portion 115, positioned between the inlet and recirculation portions 113-114, in substantially the same manner as was intermediate portion 15, is positioned sufficiently above and over a sink upon which the fixture member 110 may be installed. Relative to the fixture member 10, fixture member 110 may permit installation relative to sinks (or other items) located a further distance from the opening configured for installation of typical fixtures. Such may be more commonly encountered in industrial structures, as opposed, for example, to residential structures.

Further, while the fixture assembly 105 of FIG. 3 depicts a substantially “L-shaped” inlet and recirculation portions, 113-114, is should be appreciated that still other embodiments of fixture assemblies may incorporate any of a variety of shapes, sizes, and/or orientations, as may be desirable for any of a variety of possible installation environments. Likewise, it should be appreciated that all or any portion or combination of the remaining structural features of the water conservation system 101 may be substantially the same in structure, shape, and/or configuration to the water conservation system 1, as illustrated in FIGS. 1-2 and described above. Alternatively, the water conservation system 101 (and its respective sub-elements) may be substantially different in structure, shape, and/or configuration from that of the water conservation system 1.

### Water Recycling Assembly 230

While the various embodiments of the water conservation systems 1 and 101 illustrated in FIGS. 1-3 may include a water recycling assembly 30 that transports unused potable water back to a water heater, various embodiments of a water conservation system 201 may alternatively include a water recycling assembly 230 that may be configured to transport such water to any of a variety of secondary locations, depending upon their relative ease of installation. Such embodiments may provide valuable alternatives where the installation of a second pipe to a preexisting water heater may be unfeasible or unduly costly, such as, for example, in a preexisting structure(s) seeking to retrofit systems of the kind described herein. It should be appreciated, however, that the water recycling assembly 230 of this and other described embodiments may be used in conjunction with any of the previously or hereinafter described fixture assemblies.

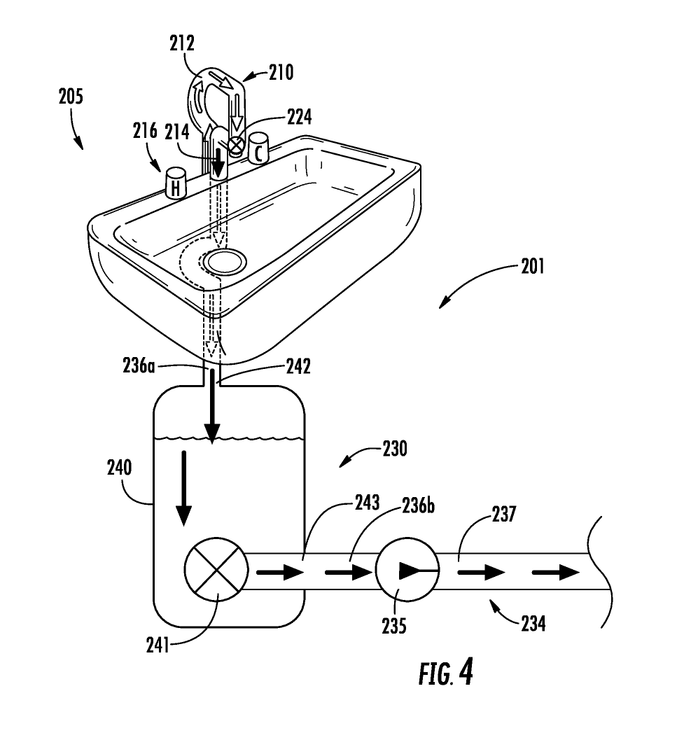

Turning to FIG. 4, the water recycling assembly 230 according to various embodiments may include a container 240, a valve assembly 241, a second (e.g., return) pipe 234, and a water pump 235. In certain embodiments, the container 240 may include a first opening 242 and a second opening 243. In such and other example embodiments, the first opening 242 is positioned such that it is located generally adjacent a top portion of the container 240 while the second opening 243 is positioned such that it is located generally adjacent a bottom portion of the container. In this manner, the container 240 may be configured, according to various embodiments, to permit the flow of water into the container via the first opening 242 and subsequently out of the container via the second opening 243, as described in further detail below.

The container 240 according to various embodiments may be sized such that it may be installed conveniently below a sink or other appliance to which the fixture member 210 is installed. Such a configuration may enable this and other example embodiments of this and similar nature to provide a feasible and economical water conservation system 201 for use with preexisting structures (e.g., preexisting homes, commercial buildings, etc.), wherein installation of the water conservation system 1 may require extensive construction and/or remodeling of previously placed plumbing pipes, walls, and the like. Indeed, in certain embodiments, the container 240 may be sized such that it fits within a cabinet housing the sink or other appliance(s). However, in other embodiments, it should be appreciated that the container 240 may be substantially differently sized, depending upon the parameters of a variety of suitable storage locations for the container 240, as may be desired or requested by a variety of users.

In various embodiments, the second (e.g., return) pipe 234 may include a runoff portion 236 (e.g., 236a, 236b) and a recirculation portion 237, substantially as described previously with regard to water conservation system 1. In certain embodiments, however, the runoff portion 236 may be configured as two separate portions of pipe, interposed by the container 240. In this manner, certain embodiments are configured such that a first segment 236a of the runoff portion 236 is positioned between and operatively connected to the fixture member 210 and first opening 242 of the container 240 while a second segment 236b of the runoff portion 236 is positioned between and operatively connected to the second opening 243 of the container 240 and the water pump 235. Such a configuration may enable the container 240 to function as a “holding tank” for ambient or cool water re-circulated through the fixture member 210 (e.g., via the recirculation portion 214), as previously described herein.

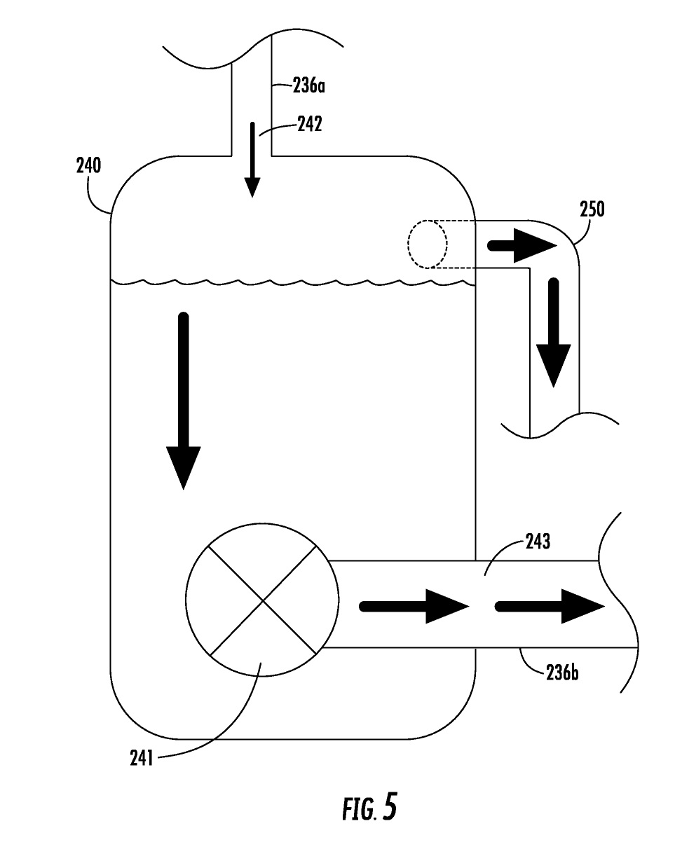

Turning now to FIG. 5, the container 240, or “holding tank” according to various embodiments may include a valve assembly 241, which may be substantially similar to, or alternatively, substantially different from the valve assembly 24 previously described. In certain example embodiments, the valve assembly 241 may be configured such that when it is open, water within the container 240 may be permitted to exit the container via the second opening 243 to subsequently travel through the second segment 236b of the runoff portion 236 of the second pipe 234. According to these and other example embodiments, any water located or released from within the container 240 may have entered the container through the first opening 242 after having passed through the first segment 236a of the runoff portion 236 of the second pipe 234. In other embodiments, the valve assembly 241 may be alternatively configured such that water is released from the container 240 when the valve is closed, as opposed to open.

Returning to FIG. 4, the second segment 236b of the runoff portion 236 according to various embodiments may be positioned between and operatively connected to the second opening 243 of the container 240 adjacent a first end and to the water pump 235 at an opposing end. In certain embodiments, the valve assembly 241 and the water pump 235 are configured to operate in substantially the same manner as the valve assembly 24 and water pump 35 previously described herein. In other embodiments, the valve assembly 241 and the water pump 235 may be configured to operate in any of a variety of ways, provided such operation sufficiently drains water stored in the container upon demand, whether automatically (e.g., via a controller (not shown), as previously described) or manually (e.g., physical user activity).

As may also be understood from FIG. 5, the container 240 according to various embodiments may further include a relief passage 250. In certain embodiments, the relief passage 250 may be configured to prevent inadvertent overflowing of the container 240 due to unusually extended periods of re-circulating ambient or cool water away from the fixture member 210. In such and other example embodiments, the relief passage 250 may include a third pipe segment configured to transport excess water away from the container 240. In certain embodiments, the excess water may be routed as such excess and drained water has traditionally been routed, such as, for example, to an external sewer drainage system. In other embodiments, the excess water may be routed via the relief passage 250 to additionally installed containers 240 located within a particular structure, if available and/or feasible. In still other embodiments, it should be appreciated that any excess water may be routed in any of a variety of ways or methods, provided such prevents inadvertent overflowing of the container 240, which may lead to costly repairs and damage, such as if a sink were over-flown.

Returning to the example embodiment illustrated in FIG. 4, it should be appreciated that all or any portion or combination of the remaining structural features of the water conservation system 201, including, but not limited to, the fixture assembly 205, the fixture member 210, the flow passage 212, the water adjustment assembly 216, the valve assembly 224, the water pump 235, and the second pipe 234 may be substantially the same in structure, shape, and/or configuration to the water conservation system 1, the fixture assembly 5, the fixture member 10, the flow passage 12, the water adjustment assembly 16, the valve assembly 24, the water pump 35, and the second pipe 34, as illustrated in FIGS. 1-2 and described above. Alternatively, the water conservation system 201 (and its respective sub-elements, as discussed above) may be substantially different in structure, shape, and/or configuration from that of the water conservation system 1 (and its respective sub-elements) illustrated in FIGS. 1-3 and described above.

### Water Recycling Assembly 330

While the various embodiments of the water conservation systems 1, 201 illustrated in FIGS. 1-5 include water recycling assemblies 30, 230 that include single electric circulation pumps 35, 235 and unitary second pipes 34, 234, various embodiments of a water conservation system 301 may alternatively incorporate a water recycling system 330 that may include multiple electric circulation pumps 335a, 335b positioned downstream of a divergence of a second pipe 334 into multiple secondary pipes 334a, 334b. Such embodiments may enable the recirculation (upon user demand) of unused potable water back to the fixture when ambient or cool water (versus hot water) is desired for dispensing from the fixture, as may be described in further detail below. It should be appreciated, however, that the water recycling assembly 330 of this and other described embodiments may be used in conjunction with any of the previously or hereinafter described fixture assemblies.

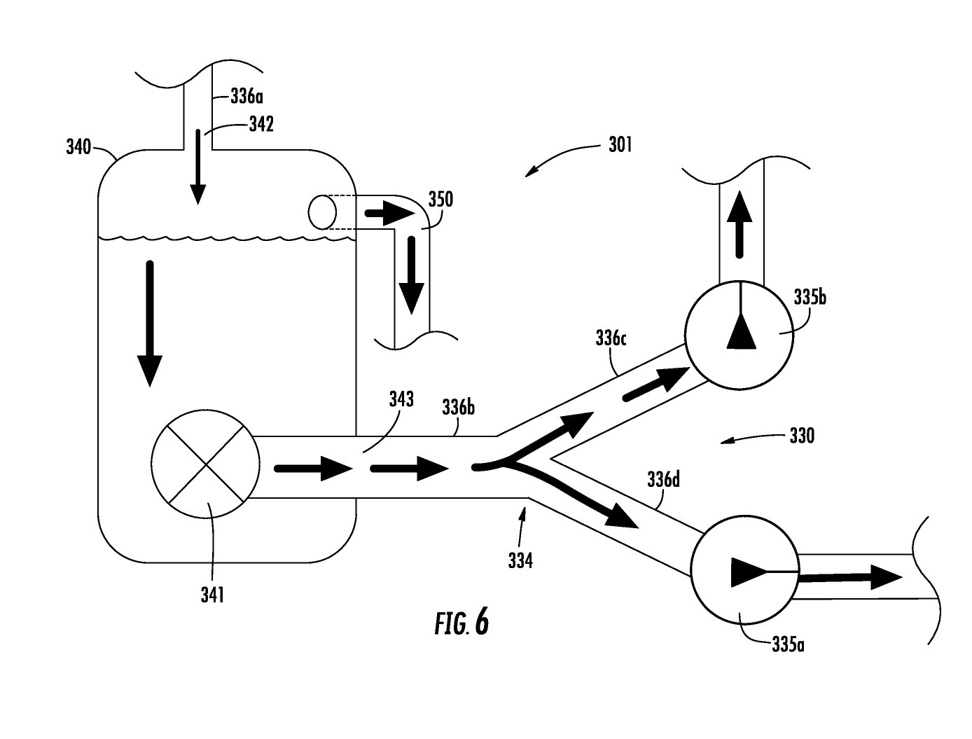

Turning to FIG. 6, the water recycling system 330 according to various embodiments may include a container 340, a valve assembly 341, a second (e.g., return) pipe 334, a first water pump 335a, and a second water pump 335b. In certain embodiments, the second pipe 334 may be configured such that a lower portion of a runoff portion 336 of the pipe is substantially “Y-shaped” or it, in other words, includes at least one fork. With such a configuration, the runoff portion 336 in these and other example embodiments may include an upstream segment 336b, a first downstream segment 336c, and a second downstream segment 336d. As such, in certain embodiments, the second water pump 335b may be positioned adjacent the first downstream segment 336c, thereby enabling unused potable water (e.g., water stored in the container 340) to be transported to multiple or selectively alternative locations. In particular, in at least one embodiment, the second water pump 335b may be configured to route unused potable water back through an inlet portion of a fixture member (not shown) when a user determines that water above a predetermined threshold is not necessary (e.g., when pouring a glass of water or when brushing teeth, etc.).

It should be appreciated that all or any portion or combination of the remaining structural features of the water conservation system 301 may be substantially the same in structure, shape, and/or configuration to the water conservation systems 1, 201; the fixture assemblies 5, 105, 205; the fixture members 10, 110, 210; the flow passages 12, 212; the water adjustment assemblies 16, 216; the valve assemblies 24, 224; the water pump 35, 235; and the second pipe 34, 234; each as illustrated in FIGS. 1-5 and described above. Alternatively, the water conservation system 301 (and its respective sub-elements) can be substantially different in structure, shape, and/or configuration from that of the water conservation system 201 (and its respective sub-elements).

### Water Recycling Assembly 430

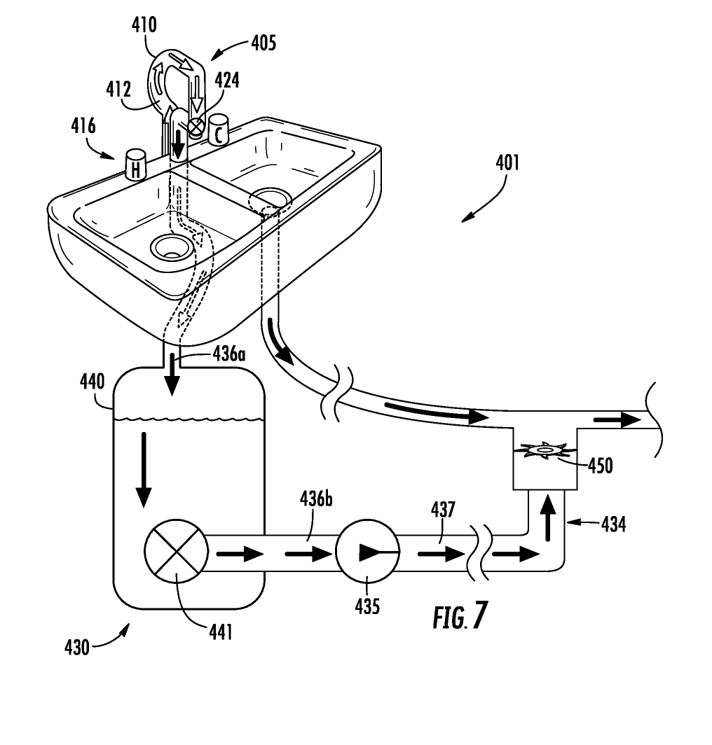

Turning to FIG. 7, various embodiments of a water recycling system 430 further illustrate certain of a variety of example secondary locations to which unused potable water may be transported subsequent to entering the recycling system of a water conservation system 401. In particular, the water recycling system 430 according to various embodiments includes a container 440, a valve assembly 441, a second (e.g. return) pipe 434 having at least a recirculation portion 437, a water pump 435, and a garbage disposal 450. In certain embodiments, the recirculation portion 437 of the second pipe 434 may be positioned between and operatively connected to the water pump 435 on a first end and to the garbage disposal 450 on a second and opposing end. In this manner, unused potable water (e.g., water held within the container 440) may be drained from the container upon demand (as previously described herein—whether automatically via a controller or manually via physical user action) and used for flushing the garbage disposal 450. In other example embodiments, it should be appreciated that the second pipe 434 may be alternatively configured between the water pump 435 and the garbage disposal 450, provided such is efficiently and effectively configured for flushing the disposal as desired by the user.

It should be appreciated that all or any portion or combination of the remaining structural features of any of the water conservation system 401, including, but not limited to, the fixture assembly 405, the fixture member 410, the flow passage 412, the water adjustment assembly 416, the valve assembly 424, the water pump 435, the container 440, and the second pipe 434 may be substantially the same in structure, shape, and/or configuration to the water conservation systems 1, 101, 201 or 301 (and their respective sub-elements), as illustrated in FIGS. 1-6 and described above. Alternatively, the water conservation system 401 may be substantially different in structure, shape, and/or configuration from that of the water conservation systems 1, 101, 201 or 301.

### Water Recycling Assembly 530

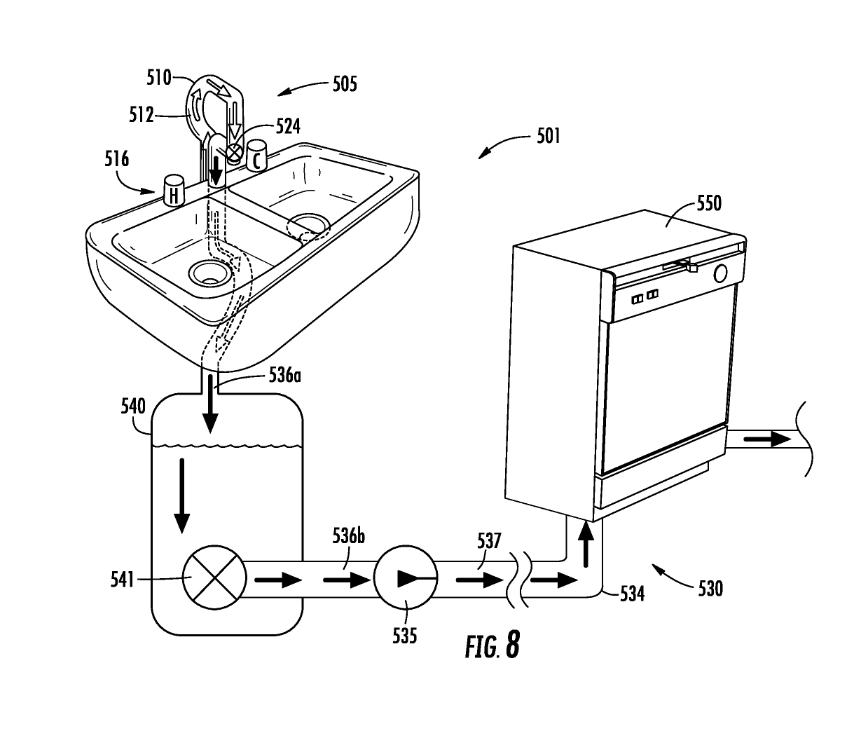

Turning to FIG. 8, various embodiments of a water recycling system 530 further illustrate certain of a variety of example secondary locations to which unused potable water may be transported subsequent to entering the recycling system of a water conservation system 501. In particular, the water recycling system 530 according to various embodiments may include a recirculation portion 537 of a second (e.g., return) pipe 534 positioned between and operatively connected to a water pump 535 on a first end and to a dishwater 550 on a second and opposing end. In this manner, any unused potable water (e.g., water held within a container 540) may be drained from the container upon demand (as previously discussed herein—whether automatically via a controller or manually via physical user action) and used during, for example, a rinse cycle being run by the dishwasher 550. In other embodiments, it should be appreciated that the second pipe 534 may be alternatively configured between the water pump 535 and the dishwasher 550, provided such is efficiently and effectively configured for rinsing dishes (not shown) within the dishwasher while minimizing the need for externally provided water, as may be desired by the user.

It should be appreciated that all or any portion or combination of the remaining structural features of any of the water conservation system 501, including, but not limited to, the fixture assembly 505, the fixture member 510, the flow passage 512, the water adjustment assembly 516, the valve assembly 524, the water pump 535, the holding tank 540, and the second pipe 534 may be substantially the same in structure, shape, and/or configuration to the water conservation systems 1, 101, 201, 301, or 401 (and their respective sub-elements), as illustrated in FIGS. 1-7 and described above. Alternatively, the water conservation system 501 may be substantially different in structure, shape, and/or configuration from that of the water conservation systems 1, 101, 201, 301, or 401.

### Water Recycling Assembly 630

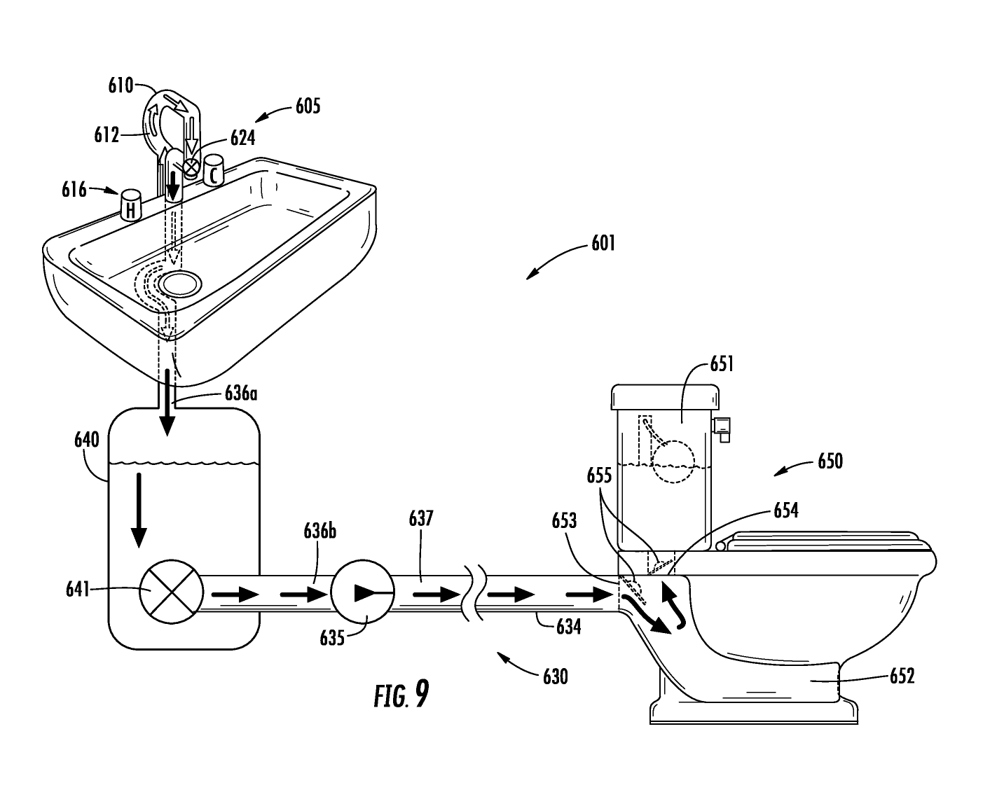

Turning to FIG. 9, various embodiments of a water recycling system 630 further illustrate certain of a variety of envisioned secondary locations to which unused potable water may be transported subsequent to entering the recycling system of a water conservation system 601. In particular, the water recycling system 630 according to various embodiments may include a recirculation portion 637 of a second (e.g., return) pipe 634 positioned between and operatively connected to a water pump 635 on a first end and to a toilet 650 on a second and opposing end. In this manner, any unused potable water (e.g., water held within a container 640) may be drained from the container upon demand (as previously discussed herein—whether automatically via a controller or manually via physical user action) and used to refill a toilet tank 651 subsequent to a user flushing the toilet 650. In at least the illustrated embodiment, the recirculation portion 637 may be configured to connect to a storage bowl 652 adapted for retrofitting around a circumference of the base of the toilet 650. The storage bowl 652 according to this and other example embodiments may include a first opening 653, a second opening 654, and two flaps 655. However, it should be appreciated that in other embodiments, the storage bowl 652 may be otherwise configured in a variety of shapes, forms, or fashions, as may be desired by a particular user or necessitated within a particular structure.

In operation, according to various embodiments, as water is drained from the toilet tank 651 upon a flushing, the water conservation system 601 may be activated (whether automatically via a controller or manually via physical user action, both as previously described) to transport unused potable water from its container 640, through the first opening 653, and into the storage bowl 652. Water pressure provided in these and other example embodiments may, in operation, force water from within the storage bowl 652, through the second opening 654, and into the drained toilet tank 651, thereby preparing the toilet for a subsequent flush, as may be necessary. In certain embodiments, the two flaps 655 may prevent any backflow of unused water, whether from the toilet tank 651 to the storage bowl 652 or alternatively from the storage bowl 652 to the container 640.

It should be appreciated that all or any portion or combination of the remaining structural features of any of the water conservation system 601, including, but not limited to, the fixture assembly 605, the fixture member 610, the flow passage 612, the water adjustment assembly 616, the valve assembly 624, the water pump 635, the holding tank 640, and the second pipe 634 may be substantially the same in structure, shape, and/or configuration to the water conservation systems 1, 101, 201, 301, 401, or 501 (and their respective sub-elements), as illustrated in FIGS. 1-8 and described above. Alternatively, the water conservation system 601 may be substantially different in structure, shape, and/or configuration from that of the water conservation systems 1, 101, 201, 301, 401, or 501.

### Water Recycling Assembly 730

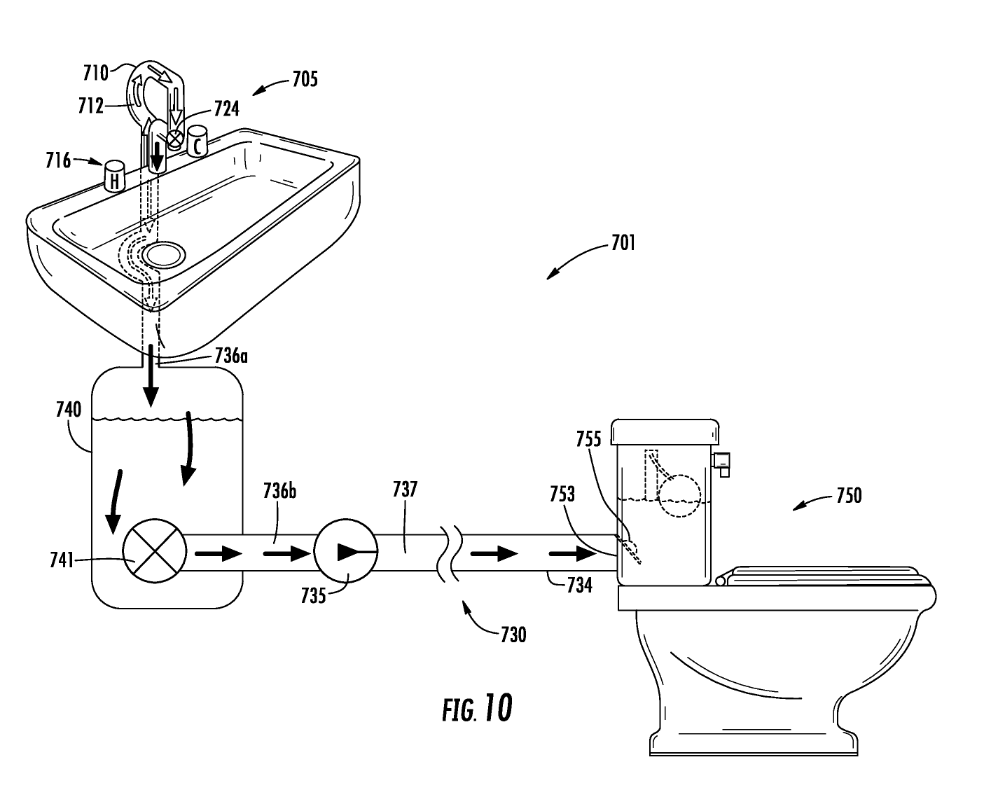

Turning to FIG. 10, various embodiments of a water recycling system 730 further illustrate certain of a variety of example secondary locations to which unused potable water may be transported subsequent to entering the recycling system of a water conservation system 701. In particular, the water recycling system 730 according to various embodiments may comprise a recirculation portion 737 of a second (e.g., return) pipe 734 positioned between and operatively connected to a water pump 735 on a first end and to a toilet 750 on a second and opposing end. In this manner, any unused potable water (e.g., water held within a container 740) may be drained from the container upon demand (as previously described herein—whether automatically via a controller or manually via physical user action) and used to refill a toilet tank 751 subsequent to a user flushing the toilet 750. In at least the illustrated example embodiment, the recirculation portion 737 may be configured to connect directly to a lower or bottom portion of the toilet tank 751 via an opening 753 fitted with a flap 755. However, it should be appreciated that in other embodiments, the recirculation portion 737 may be otherwise configured in a variety of shapes, forms, or fashions, as may be desired by a particular user or necessitated within a particular structure.

In operation, according to various embodiments, as water is drained from the toilet tank 751 upon a flushing, the water conservation system 701 may be activated (whether automatically via a controller or manually via physical user action, both as previously discussed) to transport unused potable water from its container 740, through the opening 753, and into the toilet tank 751. Water pressure provided in these and other example embodiments (e.g., via a water pump 735) may, in operation, force water from within the recirculation portion 737, through the opening 753, and into the drained toilet tank 751, thereby preparing the toilet for a subsequent flush, as may be necessary. In certain embodiments, the flap 755 may be configured to not only prevent any backflow of unused water but to also passively permit passage of water into the drained toilet tank 751 in response to a drop in water pressure atop the flap 755 (e.g., the drop in water pressure from the tank 751 being drained when flushed).

It should be appreciated that all or any portion or combination of the remaining structural features of any of the water conservation system 701, including, but not limited to, the fixture assembly 705, the fixture member 710, the flow passage 712, the water adjustment assembly 716, the valve assembly 724, the water pump 735, the holding tank 740, and the second pipe 734 may be substantially the same in structure, shape, and/or configuration to the water conservation systems 1, 101, 201, 301, 401, 501, or 601 (and their respective sub-elements), as illustrated in FIGS. 1-9 and described above. Alternatively, the water conservation system 701 may be substantially different in structure, shape, and/or configuration from that of the water conservation systems 1, 101, 201, 301, 401, 501, or 601.

### Fixture Assembly 805

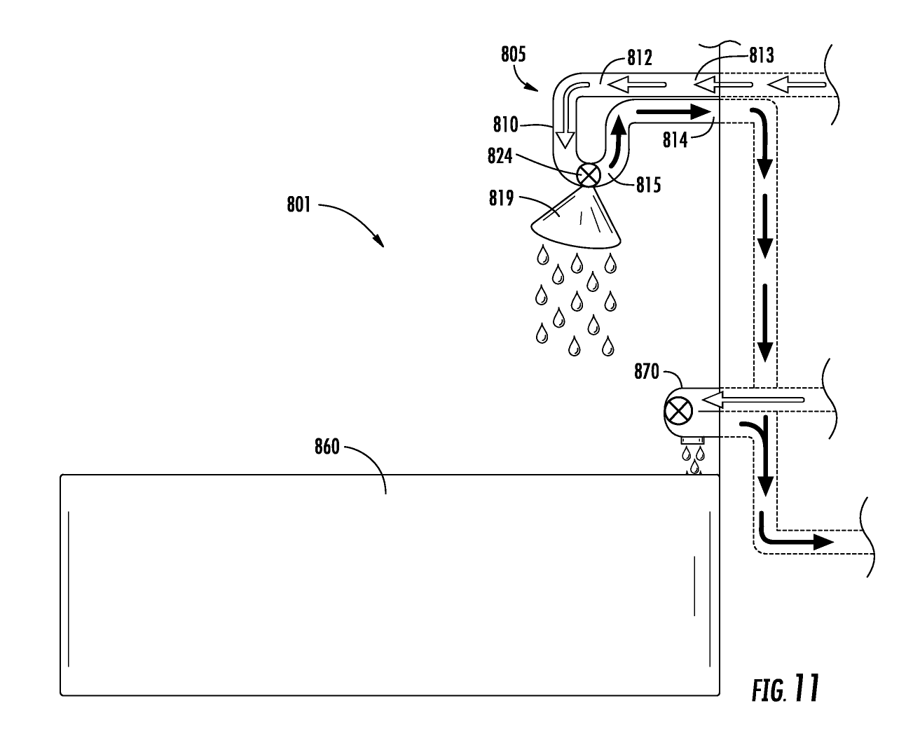

While the certain embodiments of the water conservation system 1 illustrated in FIGS. 1-2 have been described as including a fixture assembly 5, various embodiments of a water conservation system 801 may include an alternatively configured fixture assembly 805. In certain of these example embodiments, as illustrated in FIG. 11, the fixture assembly 805 may likewise include a fixture member 810 including a flow passage 812, an inlet portion 813, a recirculation portion 814, and an intermediate portion 815. However, in these and various other example embodiments, the fixture member 810 may be installed in a configuration that rotates the member approximately 90 degrees relative to the configuration as previously described. In other words, in various example embodiments, the fixture member 810 may be configured substantially horizontally, rather than vertically, thereby enabling installation of the fixture member for applications such as, for example, a shower 860, etc.

As may also be understood from FIG. 11, although the fixture assembly 805 may, in certain embodiments include a spigot 819, such may be any of a variety of types, sizes, shapes, or configurations of spigots for shower installation. Further, as also illustrated in FIG. 11, the fixture assembly 805 may, in certain embodiments, include a secondary fixture assembly 870 for installation in applications such as, for example, a bathtub, etc. In any of these and other example embodiments, it should be understood that the secondary fixture assembly 870 may be substantially the same size, shape, and/or configuration as the fixture assembly 805. However, in still other embodiments, the secondary fixture assembly 870 may be substantially different in size, shape, and/or configuration, as may be desirable. Further, although in at least the illustrated example embodiment, the water conservation system 801 may include two fixture assemblies 805, 870, wherever such may be appropriate (e.g., for installation in a shower/bath combination structural assembly), it should be appreciated that in other example embodiments, the system 801 may include either of the two fixture assemblies 805, 870 in any of a variety of combinations, as may be deemed necessary or desirable for any given application.

Returning to the embodiment illustrated in FIG. 11, it should be appreciated that all or any portion or combination of the remaining structural features of the water conservation system 801, including, but not limited to, the flow passage 812, the valve assembly 824, and the second pipe 834 may be substantially the same in structure, shape, and/or configuration to the water conservation system 1 (and its respective sub-elements, as described above) and illustrated in FIGS. 1-3. Alternatively, the water conservation system 801 (and its respective sub-elements, as discussed above) may be substantially different in structure, shape, and/or configuration from that of the water conservation system 1 (and its respective sub-elements) illustrated in FIGS. 1-3 and described above. In this regard, water may flow through the flow passage 812 and the valve assembly 824 to a water heater a number of times to a predetermined temperature is reached upon which the valve assembly 824 may be closed and the water may be released via the spigot 819 in an instance in which the water reached a temperature equaling the predetermined temperature.

### Fixture Assembly 905

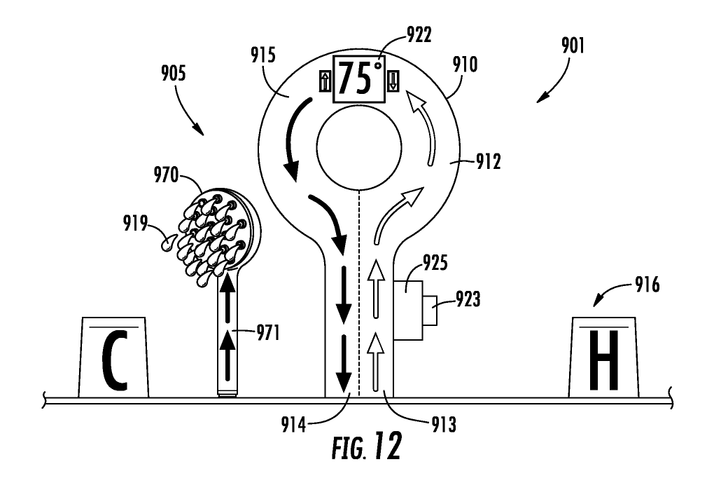

While certain embodiments of the water conservation system 1 illustrated in FIGS. 1-2 have been described as including a fixture assembly 5, various embodiments of a water conservation system 901 may include an alternatively configured fixture assembly 905. In certain of these example embodiments, as illustrated in FIG. 12, the fixture assembly 905 may likewise include a fixture member 910 including a flow passage 912, an inlet portion 913, a recirculation portion 914, and an intermediate portion 915. However, in these and various other example embodiments, the intermediate portion 915 may be substantially circular in shape (versus, for example, substantially “P-shaped” or “L-shaped” in previously described embodiments). It should be appreciated that in still other embodiments, the intermediate portion 915 may be shaped, sized, or configured in any of a variety of ways, depending upon parameters identified and as desired by a particular user.

As may also be understood from FIG. 12, the fixture assembly 905 according to various embodiments may include a spray nozzle 970 external to the fixture member 910 for fixtures designed to be used in conjunction with, for example, hair salon shampoo bowls. In certain example embodiments, the flow of water through the fixture member 910 may be transferred from between the recirculation portion 914 (e.g., flowing to a recycling assembly 930, not shown) and an input pipe 971 of the spray nozzle 970, depending upon whether the water has reached a predetermined threshold temperature (e.g., as set by a user). In these and still other example embodiments, once the diverted water is located within the input pipe 971, such may be subsequently dispensed from a spigot 919, either automatically or manually, as previously described with other various embodiments.

Referring to the example embodiment illustrated in FIG. 12, it should be appreciated that all or any portion or combination of the remaining structural features of the water conservation system 901, including, but not limited to, the flow passage 912, the controller 925, the indicator 922, the adjustment assembly 916, and the valve assembly (not shown) may be substantially the same in structure, shape, and/or configuration to the water conservation system 1 (and its respective sub-elements, as discussed above) and illustrated in FIGS. 1-3. Alternatively, the water conservation system 901 (and its respective sub-elements, as described above) may be substantially different in structure, shape, and/or configuration from that of the water conservation system 1 (and its respective sub-elements) illustrated in FIGS. 1-3 and described above.

### Digital Monitor 1040

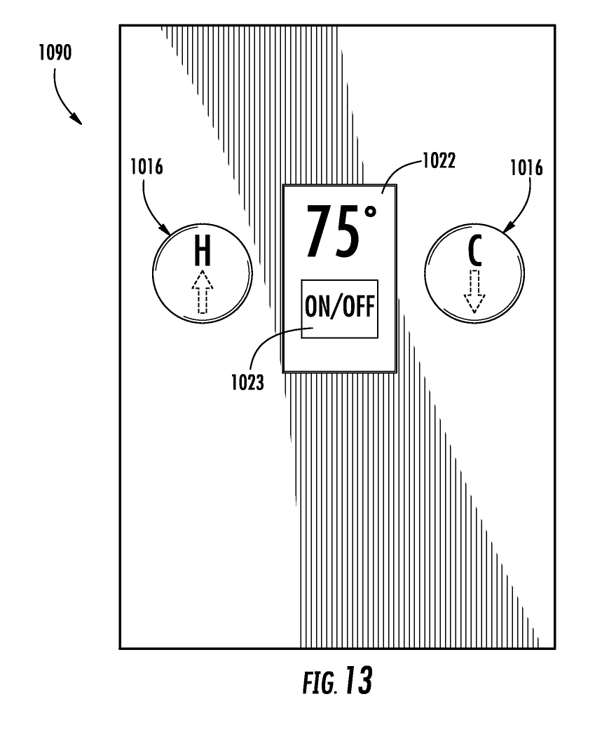

While certain example embodiments of the water conservation systems 1, 101, 201, 301, 401, 501, 601, 701, 801, and 901 illustrated in at least FIGS. 1-12 have been described as including controllers 25, 125, and 925 (and others, not shown) configured to automatically, or upon sensing a particular condition, operate the systems 1, 101, 201, 301, 401, 501, 601, 701, 801, and 901, various embodiments of any of these systems and/or still other embodiments may further include a digital monitor 1090. The digital monitor 1090, as illustrated in FIG. 13 according to exemplary embodiments may be configured to read and/or display the temperature of the water flow through the fixture members 110, 210, 410, 510, 610, 710, 810, 870, and 910. In these and still other example embodiments, the digital monitor 1090 may communicate with the controllers 25, 125, and 925, the valve assemblies 24, 124, 224, 424, 524, 624, 724, and 824, the indicators 22, 122, and 922, and/or the temperature sensors 21 and 121 (and others, not shown). In other embodiments, the digital monitor 1090 may be used in place of one or more of the controllers, valve assemblies, indicators, and/or temperature sensors.

Further, as may be seen in FIG. 13, the digital monitor 1090 according to various embodiments may include an integrated indicator 1022, release member 1023, and water adjustment assembly 1016. In certain embodiments, adjustment of the assembly 1016 may be configured to communicate with a controller (not shown, either integral to monitor 1090 or separately provided) so as to activate various components of any of the water conservation system 1-901. For example, in at least one example embodiment, adjustment of the assembly 1016 to increase the desired temperature on the indicator 1022 may cause the digital monitor 1090 to prevent discharge of any water through the spigots 19-919 until the water flow reaches the desired temperature. If and when such occurs, in certain embodiments, the digital monitor 1090 may be configured to automatically activate the valve assemblies 24-924 so as to divert water flow from the recirculation portions 14-914 of the fixture members 10-910 to the spigots (as previously described). In other embodiments, the digital monitor 1090 may be configured to merely notify a user that the desired temperature has been met and further to await a user input (e.g., via a release member 1022) before activating the valve assemblies, as previously described.

### Methods of Using Various Embodiments of the Invention

Various methods of using the various embodiments described above may exist. For purposes of illustration and not of limitation, an example method of using the water conservation system 1 will now be discussed with reference to at least FIGS. 1-2. It should be understood that this method may provide a non-limiting example for purposes of illustration not of limitation and methods of using certain of the remaining disclosed embodiments, along with any additionally example embodiments, may involve certain variations or additions to this particular method.

The first step of the method for using the water conservation system 1 may involve a user activating the system by operating the water adjustment assembly 16 (see FIG. 2) so as to establish a predetermined temperature threshold at which the user wishes water to be dispensed from the fixture member 10. In certain embodiments, operation of the assembly 16 may be by turning independently operated knobs 17, 18, while in other embodiments, the user may rotate a single knob, as has been previously described. In still other embodiments, operation of the assembly 16 may involve the user selecting a temperature via a digital monitor 1090, as depicted in at least FIG. 13. In any of these and other embodiments, once the user has selected the desired temperature threshold, the system 1 may begin transporting water to the fixture member 10.

Once water is flowing toward and through the fixture member 10, the water conservation system 1 according to various embodiments may begin sensing the temperature characteristics of the water flow, via, for example, the temperature sensor 21. Temperature readings via the temperature sensor 21 are, in certain embodiments, communicated to the controller 25, which in turn may maintain the valve assembly 24 in either a closed or open position. In at least one embodiment, if the sensed temperature remains below the predetermined (e.g., selected) user threshold, the controller 25 may instruct the valve assembly 24 to remain closed, thereby directing the water flow through a recirculation portion 14 of the fixture member 10 and away from the spigot 19. In other embodiments, dependent upon the orientation of the valve assembly 24, the controller 25 may instruct the valve assembly to remain open under such circumstances, provided such a configuration likewise diverts the water flow away from the spigot 19.

In various embodiments, the water conservation system 1 is configured to continually monitor the temperature of water flowing through the fixture member 10 (e.g., via the temperature sensor 21). In certain embodiments, upon sensing that the temperature has reached (or, alternatively, exceeded) the predetermined threshold, the system 1 may be configured to divert the flow of water away from the recirculation portion 14 of the fixture member 10 and toward the spigot 19. In at least one embodiment, the system 1 may be configured to automatically divert the flow of water toward the spigot 19 by moving the valve assembly 24 from a closed to an open position (or vice versa, depending upon orientation). In other embodiments, the system 1 may be configured to notify the user that the predetermined threshold has been met, whether via a light-activated indicator 22 or a visual display of the temperature 122 (as seen in FIG. 3, for example). In those and still other example embodiments, the user, upon notification, may depress a release member 23, thereby permitting water diverted toward the spigot 19 to be dispensed therefrom for consumption by the user.

In various embodiments, at least while the water conservation system 1 is configured to divert water flow away from the spigot 19 and through a recirculation portion 14 of the fixture member 10, the system may be further configured to transport such water via a second (e.g., return) pipe 34 to any of a variety of locations. In certain embodiments, the second pipe 34 may be configured to re-circulate unused potable water (e.g., water not yet at the predetermined temperature threshold) back into the water heater 32 for subsequent reheating, as desired. In at least one of such example embodiments, the system 1 may force such unused potable water back toward and into the water heater 32 with a water pump 35, which may be manually activated by the user or automatically activated (e.g., via the controller 25 upon determination that the predetermined threshold has not yet been met and water should continue to be diverted away from the spigot 19). In any of these and other example embodiments, when the user depresses the release member 23 (or, alternatively, the system 1 automatically diverts heated water flow to the spigot 19), the water pump 35 may be deactivated (e.g., via the controller 25), thereby preventing the flow of any additional unused potable water to, for example, the water heater 32.

Turning now to FIG. 4, a method of operating an alternative embodiment of the water conservation system 201 will now be briefly described, at least to the degree that it may involve additional or alternative steps as those previously described with respect to system 1 of FIGS. 1-2. In particular, upon activation of the water conservation system 201 and sensing (e.g., via a temperature sensor 221) that a predetermined user threshold temperature has not yet been reached, the system 201 according to certain embodiments, may be configured to transport unused potable water to a container 240 (e.g., a holding tank) that may, for example, be located underneath a sink to which the system 201 may be installed. In these and other example embodiments, the container 240 may be configured to store diverted water for later use, upon demand.

Accordingly, in certain of these embodiments of water conservation system 201, independent of operation of the fixture member 210, a user may subsequently operate any of a variety of household appliances (e.g., a garbage disposal in FIG. 7, a dishwasher in FIG. 8, and/or a toilet in FIG. 9) that require at least some amount of potable water for their operation. Turning to the non-limiting example of a toilet, upon flushing of the toilet (e.g., by a user), the water conservation system 201 according to certain embodiments may be configured to transport (either automatically or in response to manual input from a user) a required amount of potable water from the container 240 to the toilet (or, alternatively, other appliance(s)). Once sufficient water has been supplied, the system 201 according to various embodiments may be configured to be deactivated, whether automatically or manually. Subsequent activation of the system 201 according to these and other example embodiments may occur in response to subsequent flushing of the toilet and/or demand for heated water at the fixture member 210, thereby restarting the recirculation process, as previously described.

### Conclusion

The foregoing description of the various embodiments of the present invention has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention and should be interpreted in accordance with the breadth to which they are fairly, legally and equitably entitled. The drawings and preferred embodiments do not and are not intended to limit the ordinary meaning of the various embodiments in their fair and broad interpretation in any way. Although specific terms are employed herein, they are used in a generic and descriptive sense only and not for purposes of limitation.

That which is claimed:

1. A water conservation system for distributing water, said system comprising:
a fixture member comprising a first opening and being configured to transport a flow of distributed water;
a monitoring assembly configured to sense a temperature characteristic of said flow of distributed water; and
a valve assembly located adjacent said first opening, said valve assembly configured to divert said flow of distributed water away from said first opening when said temperature characteristic remains below a threshold value.

2. The water conservation system of claim 1, wherein said valve assembly is further configured to divert said flow of distributed water through said first opening when said temperature characteristic meets or exceeds the threshold value.

3. The water conservation system of claim 1, further comprising:
a water recycling assembly configured to transport said flow of distributed water away from said fixture member when said temperature threshold remains below said threshold value.

4. The water conservation system of claim 3, wherein said water recycling assembly transports said flow of distributed water to a water heater.

5. The water conservation system of claim 3, wherein said water recycling assembly further comprises:
an elongated pipe having a first end and a second end, said first end positioned adjacent said fixture member; and
a pump positioned adjacent said second end of said elongated pipe, said pump being configured to generate a force sufficient to further transport said flow of distributed water away from said fixture member.

6. The water conservation system of claim 5, wherein said generated force is sufficient to transport said flow of distributed water to a water heater.

7. The water conservation system of claim 3, wherein said water recycling assembly further comprises:
a first elongated pipe comprising a first end and a second end, said first end positioned adjacent said fixture member; and
a container positioned adjacent said second end of said first elongated pipe, said container configured to receive said flow of distributed water.

8. The water conservation system of claim 7, wherein said water recycling assembly further comprises:
a second elongated pipe comprising a first end and a second end, said first end positioned adjacent at least a portion of said container; and
a pump positioned adjacent said second end of said elongated pipe, said pump being configured to generate a force sufficient to transport said flow of distributed water away from said container.

9. The water conservation system of claim 8, wherein:
said water recycling assembly further comprises a garbage disposal; and
said force generated by said pump is configured to transport said flow of distributed water through said garbage disposal.

10. The water conservation system of claim 8, wherein:
said water recycling assembly further comprises a dishwasher; and
said force generated by said pump is configured to transport said flow of distributed water into said dishwasher.

11. The water conservation system of claim 8, wherein:
said water recycling assembly further comprises a toilet; and
said force generated by said pump is configured to transport said flow of distributed water into said toilet.

12. The water conservation system of claim 11, wherein said pump is configured to generate said force in response to a notification that said toilet has been flushed.

13. The water conservation system of claim 12, wherein said generated force is configured to refill a tank of said toilet with said flow of distributed water.

14. The water conservation system of claim 1, wherein said monitoring assembly comprises a release member configured to cause said valve assembly to divert said flow of distributed water through said first opening when said temperature characteristic meets or exceeds the threshold value.

15. The water conservation system of claim 1, wherein said monitoring assembly comprises a temperature sensor positioned adjacent said fixture member and substantially within said flow of distributed water.

16. The water conservation system of claim 15, wherein said monitoring assembly further comprises a controller configured to communicate with said temperature sensor and said valve assembly to direct said flow of distributed water based upon a comparison of said temperature characteristic and said threshold value.

17. A water conservation system for distributing water, said system comprising:
a fixture member having an internal passageway, said passageway having a first opening, said passageway being configured to transport a flow of distributed water;
a monitoring assembly configured to sense a temperature characteristic of said flow of distributed water within said passageway; and
a valve assembly configured to:
transport said flow of distributed water through said first opening when said temperature characteristic meets or exceeds a threshold value; and
transport said flow of distributed water away from said first opening when said temperature characteristic remains below said threshold value.

18. The water conservation system of claim 17, further comprising a water recycling assembly configured to transport said flow of distributed water away from said fixture member when said temperature characteristic remains below said threshold value.

19. The water conservation system of claim 18, wherein said water recycling assembly transports said flow of distributed water to a water heater.

20. The water conservation system of claim 18, wherein said water recycling assembly further comprises:
a first passageway comprising a first end and a second end, said first end positioned adjacent said fixture member;
a container positioned adjacent said second end of said first passageway, said container configured to receive said flow of distributed water;
a second passageway comprising a first end and a second end, said first end positioned adjacent at least a portion of said container; and
a pump positioned adjacent said second end of said second passageway, said pump being configured to generate a force sufficient to transport said flow of distributed water away from said container.

21. The water conservation system of claim 20, wherein:
said water recycling assembly further comprises an appliance selected from the group consisting a garbage disposal, a dishwasher, and a toilet; and
said force generated by said pump is configured to transport said flow of distributed water into said appliance.

22. A method of using a water conservation system for distributing water, said method comprising:
determining a threshold temperature characteristic for a flow of distributed water through a fixture member, said fixture member comprising a first opening;
supplying said flow of distributed water through said fixture member;
sensing a current temperature characteristic for said flow of distributed water through said fixture member;
comparing said current temperature characteristic to said threshold temperature characteristic; and
diverting said flow of distributed water away from said first opening in response to a determination that said current temperature characteristic is less than said threshold temperature characteristic.

23. The method of claim 22, further comprising diverting said flow of distributed water through said first opening in response to a determination that said current temperature characteristic equals a value of said threshold temperature characteristic.

24. The method of claim 23, wherein said diverting of said flow of distributed water through said first opening is performed automatically.

25. The method of claim 22, wherein said diverting further comprises transporting said flow of distributed water to a water heater.

25. The method of claim 22, further comprising:
transporting said flow of distributed water to a container configured to store said distributed water;
releasing said stored water from said container; and
transporting said released water to an appliance.

26. The method of claim 25, wherein said appliance is an appliance selected from the group consisting of a garbage disposal, a dishwasher, and a toilet.

27. The method of claim 25, wherein said releasing is performed automatically.
